(19) United States
(12) Patent Application Publication
(10) Pub. No.: US 2019/0004806 A1
(43) Pub. Date: Jan. 3, 2019

(54) BRANCH PREDICTION FOR FIXED DIRECTION BRANCH INSTRUCTIONS

(71) Applicant: QUALCOMM Incorporated, San Diego, CA (US)

(72) Inventor: Rami Mohammad A. AL SHEIKH, Morrisville, NC (US)

(21) Appl. No.: 15/640,441

(22) Filed: Jun. 30, 2017

(51) Int. Cl. G06F 9/38; G06F 9/30

(52) U.S. Cl. CPC G06F 9/3846; G06F 9/30058

(57) ABSTRACT

Systems and methods for branch prediction of fixed direction branch instructions involve Bloom Filters. A taken Bloom Filter records instances of a branch instruction being taken or having resolved in a taken direction; while a not-taken Bloom Filter records instances of a branch instruction not being taken, or having resolved in a not-taken direction. For a branch instruction to be executed, the taken Bloom Filter and the not-taken Bloom Filter are accessed and a direction of execution for the branch instruction is predicted using at least one of the taken Bloom Filter or the not-taken Bloom Filter.

### FIELD OF DISCLOSURE

Disclosed aspects are directed to branch prediction in processing systems. More specifically, exemplary aspects are directed to improving branch prediction for branch instructions which always resolve in the same direction, such as always-taken or always-not-taken branch instructions, and referred to herein as “fixed direction” branch instructions.

### BACKGROUND

Processing systems may employ instructions which cause a change in control flow, such as conditional branch instructions. The direction of a conditional branch instruction is based on how a condition evaluates, but the evaluation may only be known deep down an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, with a corresponding direction referred to as the “taken direction”; or a “not-taken” path which starts at the next sequential address after the conditional branch instruction, with a corresponding direction referred to as the “not-taken direction”.

When the condition is evaluated and the actual branch direction is determined, if the branch was mispredicted, (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include one or more state machines which may be trained with a history of evaluation of past and current branch instructions. But these branch prediction mechanisms can fail to accurately predict the direction of branch instructions in some scenarios. Moreover, the energy and resources expended for branch prediction are also wasteful when mispredictions occur.

Particularly, energy expenditure associated with complex branch prediction mechanisms is seen to be wasteful for some branch instructions whose branching behavior may remain invariant. For example, some branch instructions may resolve in the same direction, taken or not-taken, every time they are executed. Such branch instructions are referred to as “same direction” or “fixed direction” branch instructions in this disclosure. However, conventional branch prediction mechanisms do not recognize or provide special considerations for such fixed direction branch instructions. Moreover, conventional branch prediction mechanisms may also mispredict fixed direction branch instructions in some instances.

Thus, there is a need to improve energy consumption, efficiency, and prediction accuracy of conventional branch prediction mechanisms.

### SUMMARY

Exemplary aspects of the invention are directed to systems and method for branch prediction. In this disclosure, fixed direction branch instructions refer to branch instructions which always resolve in the same direction, always-taken or always-not-taken. For such fixed direction branch instructions, exemplary Bloom Filters are configured to identify and enable efficient prediction of the branch direction. The Bloom Filters may comprise data structures which may be indexed. In one example, an exemplary Bloom Filter may include an array of bits (e.g., a register or like memory element), wherein the bits may be indexed using branch program counter (PC) values of branch instructions. If there is a hitting entry (e.g., a bit set) in a Bloom Filter for a branch instruction at a correspondingly indexed location, this means that the Bloom Filter has recorded a history of that branch instruction. More specifically, a taken Bloom Filter records instances of a branch instruction being taken or having resolved in a taken direction; while a not-taken Bloom Filter records instances of a branch instruction not being taken, or having resolved in a not-taken direction. If there is a hitting entry in only one, but not both Bloom Filters for a branch instruction, this is taken to convey that the branch instruction is a fixed direction branch instruction with a direction corresponding to the Bloom Filter in which there was a hitting entry and the direction of the branch instruction is predicted accordingly.

For example, an exemplary aspect is directed to a method of branch prediction. The method comprises: for a branch instruction to be executed, accessing a taken Bloom Filter and a not-taken Bloom Filter, wherein the taken Bloom Filter comprises a record of branch instructions that have resolved in a taken direction at least once and the not-taken Bloom Filter comprises a record of branch instructions that have resolved in a not-taken direction at least once, and predicting a direction of execution for the branch instruction using at least one of the taken Bloom Filter or the not-taken Bloom Filter.

Another exemplary aspect is directed to an apparatus comprising a processor configured to execute branch instructions. The processor comprises a taken Bloom Filter comprising a record of branch instructions that have resolved in a taken direction at least once, a not-taken Bloom Filter comprising a record of branch instructions that have resolved in a not-taken direction at least once, and logic configured to predict a direction of execution for a branch instruction based on at least one of the taken Bloom Filter or the not-taken Bloom Filter.

Yet another exemplary aspect is directed to a non-transitory computer readable storage medium comprising code, which, when executed by a computer, causes the computer to perform operations for branch prediction. The non-transitory computer readable storage medium comprises: for a branch instruction to be executed, code for accessing a taken Bloom Filter and a not-taken Bloom Filter, wherein the taken Bloom Filter comprises a record of branch instructions that have resolved in a taken direction at least once and the not-taken Bloom Filter comprises a record of branch instructions that have resolved in a not-taken direction at least once, and code for predicting a direction of execution for the branch instruction using at least one of the taken Bloom Filter or the not-taken Bloom Filter.

Yet another exemplary aspect is directed to apparatus comprising: means for executing branch instructions, a first means for recording branch instructions that have resolved in a taken direction at least once, a second means for recording branch instructions that have resolved in a not-taken direction at least once, and means for predicting a direction of execution for a branch instruction based on at least one of the first means or the second means.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a processing system according to aspects of this disclosure

FIG. 2 illustrates Bloom Filters, according to aspects of this disclosure.

FIG. 3 illustrates a sequence of events pertaining to an exemplary method according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to improving branch prediction efficiency, accuracy, and energy consumption. Specifically, in this disclosure, fixed direction branch instructions are considered, which, as previously mentioned, are branch instructions which always resolve in the same direction, always-taken or always-not-taken. For such fixed direction branch instructions, exemplary designs such as Bloom Filters are disclosed, which are configured to identify and enable efficient prediction of the branch direction.

The Bloom Filters in this disclosure may comprise data structures which may be indexed. In one example, an exemplary Bloom Filter may include an array of bits (e.g., a register or like memory element), wherein the bits may be indexed using branch program counter (PC) values of branch instructions. If there is a hitting entry (e.g., a bit set) in a Bloom Filter for a branch instruction at a correspondingly indexed location, this means that the Bloom Filter has recorded a history of that branch instruction. More specifically, a taken Bloom Filter records instances of a branch instruction being taken or having resolved in a taken direction; while a not-taken Bloom Filter records instances of a branch instruction not being taken, or having resolved in a not-taken direction. If there is a hitting entry in only one, but not both Bloom Filters for a branch instruction, this is taken to convey that the branch instruction is a fixed direction branch instruction.

The direction of execution for fixed direction branch instructions is derived from the Bloom Filter in which there was a hitting entry (i.e., the branch instruction is always-taken if there is hit in only the taken Bloom Filter; or similarly, the branch instruction is always-not-taken if there is hit in only the not-taken Bloom Filter). For such fixed direction branch instructions, conventional branch prediction mechanisms are bypassed. In this manner, an accurate prediction is obtained for the fixed direction branch instructions and energy consumption and inaccuracies of the conventional branch prediction mechanisms are avoided.

It is also recognized that aspects of this disclosure may be extended to branch instructions whose resolutions may deviate a relatively small or insignificant number of times from the fixed direction as discussed above. For instance, alternative structures for the Bloom Filters are also disclosed, which may be used to obtain predictions for branch instructions which are “almost always” (e.g., more than 99% of the time) taken or not-taken. For example, the above-mentioned Bloom Filters may alternatively be implemented using arrays of counters (rather than single bits), wherein the counters may be indexed using the PCs of branch instructions. At an indexed location, a counter for a corresponding branch instruction, if present (i.e., there is a counter in a hitting entry), may provide information regarding how many times that branch instruction respectively resolved in a taken direction (for the case of a taken Bloom Filter) or how many times the branch instruction resolved in a not-taken direction (for the case of the not-taken Bloom Filter). Thus, for a branch instruction, the number of times the branch instruction was taken, and the number of times the branch instruction was not-taken may be determined by reading both the taken Bloom Filter and the not-taken Bloom Filter for the branch instruction. These numbers may be compared, or a proportion of times the branch instruction was taken or not-taken (e.g., as a percentage of the overall number of instances of the branch instruction obtained as a sum of the two count values) may be determined. If the proportion of the number of times the branch was taken is very high (e.g., greater than the 99% threshold) the branch instruction may be predicted as taken; or alternatively, if the proportion of the number of times the branch was not-taken is very high (e.g., greater than the 99% threshold) the branch instruction may be predicted as not-taken.

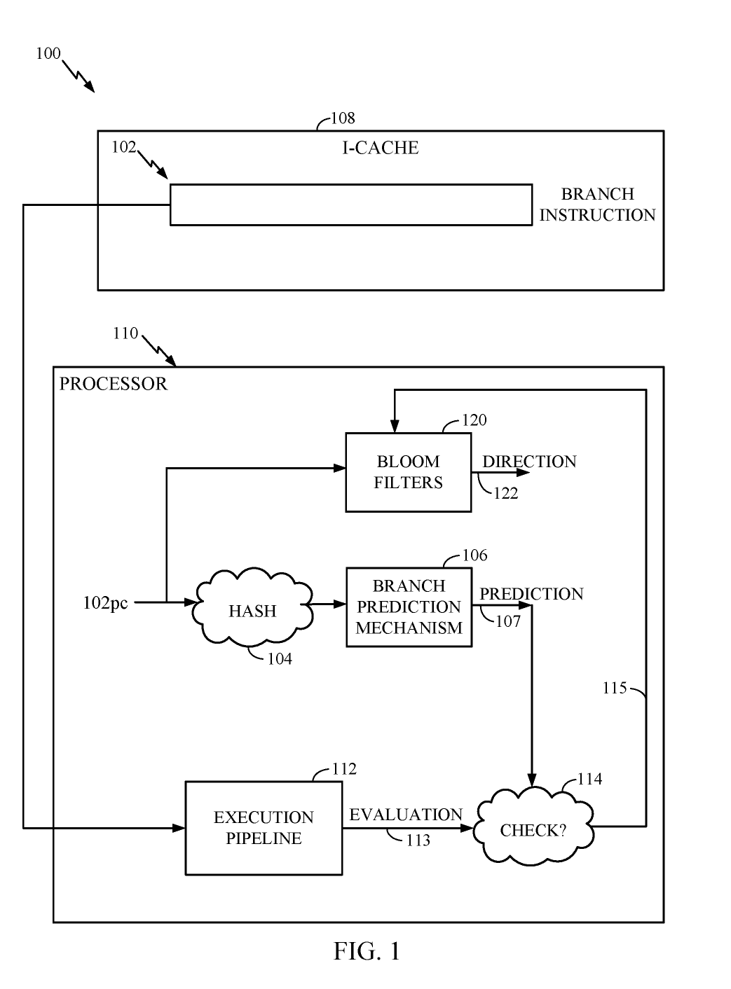

With reference now to FIG. 1, an exemplary processing system 100 in which aspects of this disclosure may be employed, is shown. Processing system 100 is shown to comprise processor 110 coupled to instruction cache 108. Although not shown in this view, additional components such as functional units, input/output units, interface structures, memory structures, etc., may also be present but have not been explicitly identified or described as they may not be germane to this disclosure. As shown, processor 110 may be configured to receive instructions from instruction cache 108 and execute the instructions using for example, execution pipeline 112. Execution pipeline 112 may be configured to include one or more pipelined stages such as instruction fetch, decode, execute, write back, etc., as known in the art. Representatively, a branch instruction is shown in instruction cache 108 and identified as instruction 102.

In an exemplary implementation, branch instruction 102 may have a corresponding address or program counter (PC) value of 102pc. Processor 110 is generally shown to include branch prediction mechanism 106, which may further include branch prediction units such as a history table comprising a history of behavior of prior branch instructions, state machines such as branch prediction counters/bimodal predictors, etc., as known in the art. When branch 102 is fetched by processor 110 for execution, logic such as hash 104 (e.g., implementing an XOR function) may utilize the address or PC value 102pc and/or other information from branch instruction 102 to access branch prediction mechanism and retrieve prediction 107, which represents a prediction (also referred to as a dynamic prediction) of branch instruction 102.

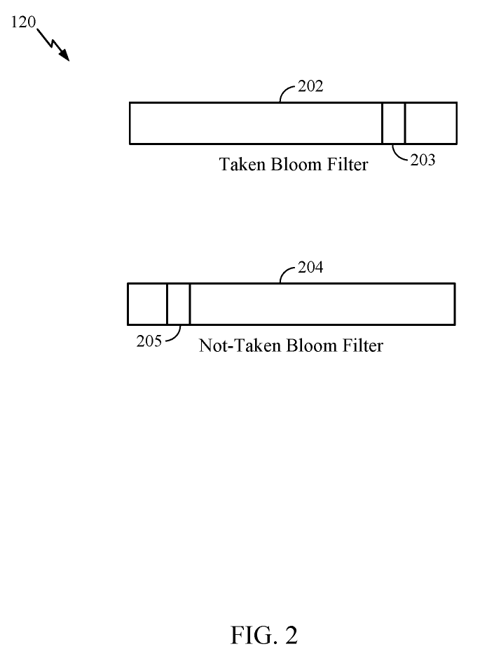

In exemplary aspects, processor 110 also includes Bloom Filters 120, an example implementation of which will be further described with reference to FIG. 2. Bloom Filters 120 may be indexed by PC value 102pc of branch instruction 102, for example, and provide direction 122 (e.g., taken/not-taken) for fixed direction branch instructions or branch instructions with a strong statistical bias of taken/not-taken. Branch instructions for which direction 122 may be obtained from Bloom Filters 120 may be executed in a direction (taken or not-taken) corresponding to direction 122, while ignoring prediction 107 provided by branch prediction mechanism 106. In one implementation, if direction 122 is available from Bloom Filters 120 for a particular branch instruction, prediction 107 from branch prediction mechanism 106 may be avoided or ignored and further, branch prediction mechanism 106 may be gated off or powered down for that branch instruction, which can lead to energy savings for the cases of fixed direction branch instructions.

Continuing with the description of FIG. 1, branch instruction 102 may be speculatively executed in execution pipeline 112 (based on a direction derived from either prediction 107 or direction 122). After traversing one or more pipeline states, an actual evaluation of branch instruction 102 will be known, and this is shown as evaluation 113. Evaluation 113 is compared with prediction 107 in prediction check block 114 to determine whether evaluation 113 matched prediction 107 (i.e., branch instruction 102 was correctly predicted) or mismatched prediction 107 (i.e., branch instruction 102 was mispredicted). In an example implementation, bus 115 comprises information comprising the correct evaluation 113 (taken/not-taken) as well as whether branch instruction 102 was correctly predicted or mispredicted. The information on bus 115 may be supplied to Bloom Filters 120.

Referring now to FIG. 2 in conjunction with FIG. 1, an example implementation of Bloom Filters 120 is illustrated. In some example instruction streams executed by processor 110, there may be some fixed direction branch instructions which are always-taken or always-not-taken. Since predicting such fixed direction branch instructions using branch prediction mechanism 106 may not be energy/power efficient, and moreover, prediction 107 may be incorrect (i.e., not align with the direction of the fixed direction branch instruction), Bloom Filters 120 may be used instead for such fixed direction branch instructions. More specifically, Bloom Filters 120 may comprise two component Bloom Filters: taken Bloom Filter 202 and not-taken Bloom Filter 204. Bloom Filters 120 are configured to predict the direction of execution for the branch instruction using at least one of the taken Bloom Filter 202 or the not-taken Bloom Filter 204 according to exemplary aspects which will be described in the following sections. Furthermore, in some aspects, Bloom Filter 120 may comprise corresponding logic configured to predict a direction of speculative execution for a branch instruction based on at least one of taken Bloom Filter 202 or not-taken Bloom Filter 204, it is also possible (although it will be understood that such logic to be provided elsewhere within processing system 100 or more specifically within processor 110).

As previously discussed, the Bloom Filters, taken Bloom Filter 202 and not-taken Bloom Filter 204, may comprise data structures which may be indexed. For instance, taken Bloom Filter 202 and not-taken Bloom Filter 204 may each include an array of bits (e.g., a register or like memory element), wherein the bits may be indexed using branch program counter (PC) values of branch instructions. For example, in FIG. 2, entry 203 may represent one bit of taken Bloom Filter 202 which may correspond to an always-taken branch instruction, and may be at a location indexed by the PC of the always-taken branch instruction. Similarly, entry 205 may represent one bit of not-taken Bloom Filter 204 which may correspond to an always-not-taken branch instruction, and may be at a location indexed by the PC of the always-not-taken branch instruction.

In one implementation, if there exists an entry 203/205 of a respective Bloom Filter 202/204 for a branch instruction at a correspondingly indexed location, this means that the corresponding Bloom Filter 202/204 has recorded a history of that branch instruction. If such an entry 203/205 exists for a branch instruction in the corresponding Bloom Filter 202/204, this situation is referred to as a hit and the entry is referred to as a hitting entry. In more detail, taken Bloom Filter 202 records instances of a branch instruction being taken, while a not-taken Bloom Filter 204 records instances of a branch instruction not being taken. If there is a hitting entry in only one, but not both Bloom Filters for a branch instruction, this situation is taken to convey that the branch instruction is a fixed direction branch instruction.

The direction of execution for the fixed direction branch instructions is derived from the Bloom Filter in which there was a hit (i.e., the branch instruction is always-taken if there is hit in only the taken Bloom Filter; or similarly, the branch instruction is always-not-taken if there is hit in only the not-taken Bloom Filter). Taken Bloom Filter 202 may be configured to capture or record program counter (PC) values of always-taken fixed direction branch instructions and not-taken Bloom Filter 204 may be used to record PC values of always-not-taken branch instructions. In various implementations, taken Bloom Filter 202 and not-taken Bloom Filter 204 may be of different sizes, e.g., taken Bloom Filter 202 can be larger or have more entries than not-taken Bloom Filter 204.

In an implementation, when a branch instruction such as branch instruction 102 is fetched, its associated branch PC 102pc is used to index both taken Bloom Filter 202 and not-taken Bloom Filter 204 of Bloom Filters 120. When Bloom Filters 120 are accessed in this manner, two scenarios may arise.

In a first scenario, there may be a hit in both taken Bloom Filter 202 and not-taken Bloom Filter 204 (i.e., there may be a hitting entry which is set, e.g., to value “1”, at an indexed location using branch PC 102pc in both taken Bloom Filter 202 and not-taken Bloom Filter 204), or a miss in both taken Bloom Filter 202 and not-taken Bloom Filter 204 (i.e., there may not be a hitting entry at an indexed location using branch PC 102pc in both taken Bloom Filter 202 and not-taken Bloom Filter 204). If there is a hit in both taken Bloom Filter 202 and not-taken Bloom Filter 204 for branch PC 102pc of branch instruction 102, this means that branch instruction 102 may have been taken at least once and not-taken at least once, and thus branch instruction 102 would not be a fixed direction branch instruction which is always-taken or always-not-taken. If there is a miss in both taken Bloom Filter 202 and not-taken Bloom Filter 204, this means that there is not sufficient information in Bloom Filters 120 for branch instruction 102. Thus, in both cases, Bloom Filters 120 may not be relied upon for providing a direction for branch instruction 102. Instead, branch prediction mechanism 106 may be consulted to obtain prediction 107 for the speculative execution of branch instruction 102.

In one aspect, if there is a hit in both taken Bloom Filter 202 and not-taken Bloom Filter 204 for branch instruction 102, then the corresponding hitting entries are reset in both taken Bloom Filter 202 and not-taken Bloom Filter 204, which enables adapting the implementation of Bloom Filters 120 to changes in the phase of programs (e.g., branch instruction 102 may have the behavior of a fixed direction branch instruction in one program phase, while in a different program phase, branch instruction 102 may be sometimes taken and sometimes not-taken). In another aspect, entries at the same locations (which may be randomly chosen) in both taken Bloom Filter 202 and not-taken Bloom Filter 204 may be reset in a periodic manner, e.g., every 1 million instructions or 10 thousand processor cycles, for example. In another aspect, the number of entries that are set in both taken Bloom Filter 202 and not-taken Bloom Filter 204 may be monitored, and if a proportion of these set entries (out of the total number of entries) exceeds a pre-specified threshold number, for example, then either both taken Bloom Filter 202 and not-taken Bloom Filter 204 may be fully reset or the same locations (which may be randomly chosen) in both taken Bloom Filter 202 and not-taken Bloom Filter 204 may be reset.

A second scenario involves a hit it in only one of the two Bloom Filters: either taken Bloom Filter 202 or not-taken Bloom Filter 204 for branch instruction 102. In this case, only the taken Bloom Filter 202 or not-taken Bloom Filter 204 in which there was a hit has a record of branch instruction 102 in its history of execution in processor 110. Correspondingly, direction 122 is set based on the Bloom Filter in which there was a hit and direction 122 is used instead of prediction 107 (branch prediction mechanism 106 may be powered down or gated off to save energy when there is a hit in only one of the two Bloom Filters 202 or 204). For example, if there was a hit in taken Bloom Filter 202, then the direction of branch instruction 102 may be set to taken. On the other hand, if there was a hit in not-taken Bloom Filter 204, then the direction of branch instruction 102 may be set to not-taken.

In another implementation, entries of Bloom Filters 120, e.g., entry 203 of taken Bloom Filter 202 and entry 205 of not-taken Bloom Filter 204 may comprise counters (e.g., of 2-bits or more) to count the number of instances in which respective branch instructions resolve in corresponding directions. For instance, entry 203 may include a taken counter which tracks the number of times a branch instruction with a PC which indexes to entry 203 was taken. Similarly, entry 205 may include a not-taken counter which tracks the number of times a branch instruction with a PC which indexes to entry 205 was not-taken. In this implementation, branch instructions which almost always resolve in the same direction, or a fixed direction branch instruction which may have insignificant or relatively minor deviations from the fixed direction, may be tracked and their directions predicted. Thus, the same branch instruction may have entries in both taken Bloom Filter 202 and as well as not-taken Bloom Filter 204 in this implementation and be predicted using Bloom Filters 120.

In more detail, the values of taken counter and not-taken counter may be obtained by accessing entries of taken Bloom Filter 202 and not-taken Bloom Filter 204 at corresponding locations indexed by the PC of a branch instruction. If there are hitting entries in both taken Bloom Filter 202 and not-taken Bloom Filter 204, the corresponding values of the taken counter and the not-taken counter from these respective hitting entries are compared. Alternatively, a proportion of the taken counter may be compared to the sum of the values of the taken counter and the not-taken counter to obtain a taken percentage of the number of times the branch instruction was taken. Alternatively, a not-taken percentage of the number of times the branch instruction was not-taken may be similarly calculated. If the taken percentage is substantially high, e.g., greater than a threshold percentage of 99%, then the branch instruction may be predicted as taken. On the other hand, if the not-taken percentage is substantially high, e.g., greater than a threshold percentage of 99%, then the branch instruction may be predicted as not-taken. Such branch instructions with a substantial bias in one direction may be referred to as substantially fixed direction branch instructions. Accordingly, using counters rather than single bits in alternative implementations of Bloom Filters 120, directions of substantially fixed direction branch instructions may also be predicted.

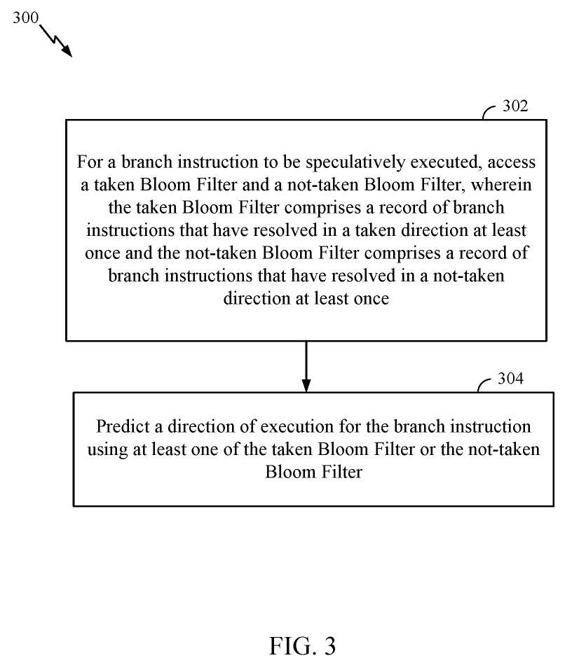

Accordingly, it will be appreciated that exemplary aspects include various methods for performing the processes, functions and/or algorithms disclosed herein. For example, FIG. 3 illustrates a method 300 of branch prediction.

In Block 302, method 300 comprises for a branch instruction to be speculatively executed, accessing a taken Bloom Filter and a not-taken Bloom Filter, wherein the taken Bloom Filter comprises a record of branch instructions that have resolved in a taken direction at least once and the not-taken Bloom Filter comprises a record of branch instructions that have resolved in a not-taken direction at least once (e.g., indexing, using branch PC 102pc, taken Bloom Filter 202 and not-taken Bloom Filter 204 for branch instruction 102).

Block 304 comprises predicting a direction of execution for the branch instruction using at least one of the taken Bloom Filter or the not-taken Bloom Filter (e.g., predicting the branch instruction 102 as an always-taken fixed direction branch instruction or an always-not-taken fixed direction branch instruction based on whether there is a hit in only the taken Bloom Filter 202 or the not-taken Bloom Filter 204).

Furthermore, exemplary aspects of this disclosure are also directed to systems comprising means for performing the functionality described herein. For example, an exemplary apparatus (e.g., processing system 100) includes means for executing branch instructions (e.g., processor 110, or more specifically, execution pipeline 112). As such the apparatus can include a first means for recording branch instructions that have resolved in a taken direction at least once (e.g., taken Bloom Filter 202) and a second means for recording branch instructions that have resolved in a not-taken direction at least once (e.g., not-taken Bloom Filter 204). The apparatus may also include means for predicting a direction of execution for a branch instruction based on at least one of the first means or the second means (e.g., Bloom Filter 120).

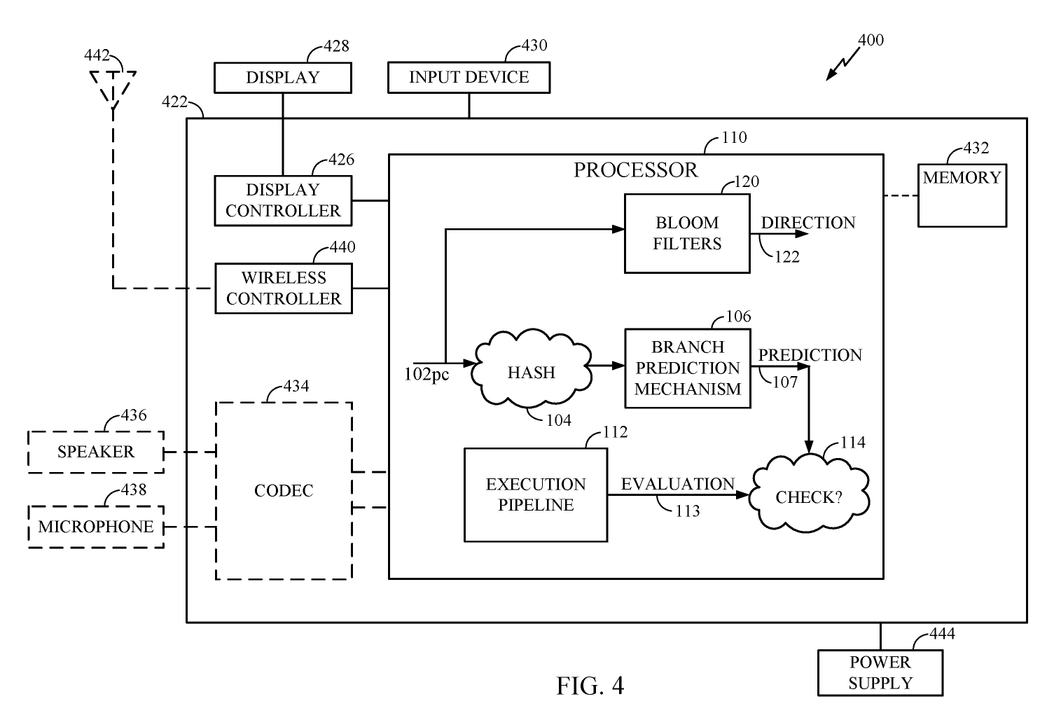

Another example apparatus in which exemplary aspects of this disclosure may be utilized, will now be discussed in relation to FIG. 4. FIG. 4 shows a block diagram of computing device 400. Computing device 400 may correspond to an exemplary implementation of a processing system 100 of FIG. 1, wherein processor 110 may be configured to perform method 300 of FIG. 3. In the depiction of FIG. 4, computing device 400 is shown to include processor 110, with only limited details (including Bloom Filter 120, branch prediction mechanism 106, execution pipeline 112 and prediction check block 114) reproduced from FIG. 1, for the sake of clarity. Notably, in FIG. 4, processor 110 is exemplarily shown to be coupled to memory 432 and it will be understood that other memory configurations known in the art such as cache 108 have not been shown, although they may be present in computing device 400.

FIG. 4 also shows display controller 426 that is coupled to processor 110 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 110 and speaker 436 and microphone 438 can be coupled to CODEC 434; and wireless antenna 442 coupled to wireless controller 440 which is coupled to processor 110. Where one or more of these optional blocks are present, in a particular aspect, processor 110, display controller 426, memory 432, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 110 and memory 432, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for branch prediction of fixed direction branch instructions. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of branch prediction, the method comprising:
for a branch instruction to be executed, accessing a taken Bloom Filter and a not-taken Bloom Filter, wherein the taken Bloom Filter comprises a record of branch instructions that have resolved in a taken direction at least once and the not-taken Bloom Filter comprises a record of branch instructions that have resolved in a not-taken direction at least once; and
predicting a direction of execution for the branch instruction using at least one of the taken Bloom Filter or the not-taken Bloom Filter.

2. The method of claim 1, comprising predicting the direction of execution for the branch instruction using at least one of the taken Bloom Filter or the not-taken Bloom Filter if there is a hit in only one of the taken Bloom Filter or the not-taken Bloom Filter for the branch instruction,
wherein if there is a hit in the taken Bloom Filter, the taken Bloom Filter comprises an entry at a location indexed by a program counter (PC) of the branch instruction and if there is a hit in the not-taken Bloom Filter, the not-taken Bloom Filter comprises an entry at a location indexed by a program counter (PC) of the branch instruction.

3. The method of claim 2, comprising predicting the direction of execution of the branch instruction as taken if there is a hit in only the taken Bloom Filter but not in the not-taken Bloom Filter, wherein the branch instruction is an always-taken branch instruction.

4. The method of claim 2, comprising predicting the direction of execution of the branch instruction as not-taken if there is a hit in only the not-taken Bloom Filter but not in the taken Bloom Filter, wherein the branch instruction is an always-not-taken branch instruction.

5. The method of claim 2, comprising ignoring a branch prediction mechanism comprising a state machine and branch history if there is the hit in only one of the taken Bloom Filter or the not-taken Bloom Filter.

6. The method of claim 5, further comprising gating off or powering down the branch prediction mechanism.

7. The method of claim 2 comprising speculatively executing the branch instruction based on a prediction provided by a branch prediction mechanism comprising a state machine and branch history if there is a hit in both the taken Bloom Filter and the not-taken Bloom Filter or if there is a miss in both the taken Bloom Filter and the not-taken Bloom Filter.

8. The method of claim 7, further comprising if there is a hit in both the taken Bloom Filter and the not-taken Bloom Filter, resetting the hitting entry in both the taken Bloom Filter and the not-taken Bloom Filter.

9. The method of claim 1, wherein each entry of the taken Bloom Filter comprises a taken counter for counting a number of instances a corresponding branch instruction indexing the entry of the taken Bloom Filter resolved in a taken direction, and wherein each entry of the not-taken Bloom Filter comprises a not-taken counter for counting a number of instances a corresponding branch instruction indexing the entry of the not-taken Bloom Filter resolved in a not-taken direction, and wherein predicting the direction of the branch instruction is based on values of taken counter and the not-taken counter of the branch instruction.

10. The method of claim 9, comprising predicting the direction of the branch instruction as taken if the value of the taken counter is substantially greater than the value of the not-taken counter.

11. The method of claim 9, comprising predicting the direction of the branch instruction as not-taken if the value of the not-taken counter is substantially greater than the value of the taken counter.

12. The method of claim 1, wherein the taken Bloom Filter is larger or has more entries than the not-taken Bloom Filter.

13. An apparatus comprising:
a processor configured to execute branch instructions, wherein the processor comprises:
a taken Bloom Filter comprising a record of branch instructions that have resolved in a taken direction at least once;
a not-taken Bloom Filter comprising a record of branch instructions that have resolved in a not-taken direction at least once; and
logic configured to predict a direction of execution for a branch instruction based on at least one of the taken Bloom Filter or the not-taken Bloom Filter.

14. The apparatus of claim 13, wherein the logic is further configured to predict the direction of execution for the branch instruction based on at least one of the taken Bloom Filter or the not-taken Bloom Filter if there is a hit in only one of the taken Bloom Filter or the not-taken Bloom Filter for the branch instruction,
wherein if there is a hit in the taken Bloom Filter, the taken Bloom Filter comprises an entry at a location indexed by a program counter (PC) of the branch instruction and if there is a hit in the not-taken Bloom Filter, the not-taken Bloom Filter comprises an entry at a location indexed by a program counter (PC) of the branch instruction.

15. The apparatus of claim 14, wherein the logic is further configured to predict the direction of execution of the branch instruction as taken if there is a hit in only the taken Bloom Filter but not in the not-taken Bloom Filter, wherein the branch instruction is an always-taken branch instruction.

16. The apparatus of claim 14, wherein the logic is further configured to predict the direction of execution of the branch instruction as not-taken if there is a hit in only the not-taken Bloom Filter but not in the taken Bloom Filter, wherein the branch instruction is an always-not-taken branch instruction.

17. The apparatus of claim 14, wherein the processor further comprises a branch prediction mechanism comprising a state machine and branch history, wherein a prediction by the branch prediction mechanism is ignored if there is the hit in only one of the taken Bloom Filter or the not-taken Bloom Filter.

18. The apparatus of claim 17, wherein the branch prediction mechanism is gated off or powered down.

19. The apparatus of claim 17, wherein the branch instruction is speculatively executed based on a prediction provided by a branch prediction mechanism if there is a hit in both the taken Bloom Filter and the not-taken Bloom Filter or if there is a miss in both the taken Bloom Filter and the not-taken Bloom Filter.

20. The apparatus of claim 19, wherein if there is a hit in both the taken Bloom Filter and the not-taken Bloom Filter, the hitting entry is configured to be reset in both the taken Bloom Filter and the not-taken Bloom Filter.

21. The apparatus of claim 12, wherein each entry of the taken Bloom Filter comprises a taken counter configured to count a number of instances a corresponding branch instruction indexing the entry of the taken Bloom Filter resolved in a taken direction, and wherein each entry of the not-taken Bloom Filter comprises a not-taken counter configured to count a number of instances a corresponding branch instruction indexing the entry of the not-taken Bloom Filter resolved in a not-taken direction, and wherein the logic is further configured to predict the direction of the branch instruction based on values of taken counter and the not-taken counter of the branch instruction.

22. The apparatus of claim 21, wherein the logic is further configured to predict the direction of the branch instruction as taken if the value of the taken counter is substantially greater than the value of the not-taken counter.

23. The apparatus of claim 21, wherein the logic is configured to predict the direction of the branch instruction as not-taken if the value of the not-taken counter is substantially greater than the value of the taken counter.

24. The apparatus of claim 12, wherein the taken Bloom Filter is larger or has more entries than the not-taken Bloom Filter.

25. The apparatus of claim 12, integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

26. A non-transitory computer readable storage medium comprising code, which, when executed by a computer, causes the computer to perform operations for branch prediction, the non-transitory computer readable storage medium comprising:
for a branch instruction to be executed, code for accessing a taken Bloom Filter and a not-taken Bloom Filter, wherein the taken Bloom Filter comprises a record of branch instructions that have resolved in a taken direction at least once and the not-taken Bloom Filter comprises a record of branch instructions that have resolved in a not-taken direction at least once; and
code for predicting a direction of execution for the branch instruction using at least one of the taken Bloom Filter or the not-taken Bloom Filter.

27. The non-transitory computer readable storage medium of claim 26, comprising code for predicting the direction of execution for the branch instruction using at least one of the taken Bloom Filter or the not-taken Bloom Filter if there is a hit in only one of the taken Bloom Filter or the not-taken Bloom Filter for the branch instruction,
wherein if there is a hit in the taken Bloom Filter, the taken Bloom Filter comprises an entry at a location indexed by a program counter (PC) of the branch instruction and if there is a hit in the not-taken Bloom Filter, the not-taken Bloom Filter comprises an entry at a location indexed by a program counter (PC) of the branch instruction.

28. The non-transitory computer readable storage medium of claim 27, comprising code for predicting the direction of execution of the branch instruction as taken if there is a hit in only the taken Bloom Filter but not in the not-taken Bloom Filter, wherein the branch instruction is an always-taken branch instruction.

29. The non-transitory computer readable storage medium of claim 27, comprising code for predicting the direction of execution of the branch instruction as not-taken if there is a hit in only the not-taken Bloom Filter but not in the taken Bloom Filter, wherein the branch instruction is an always-not-taken branch instruction.

30. An apparatus comprising:
means for executing branch instructions;
a first means for recording branch instructions that have resolved in a taken direction at least once;
a second means for recording branch instructions that have resolved in a not-taken direction at least once; and
means for predicting a direction of execution for a branch instruction based on at least one of the first means or the second means.
